(19) United States
(12) Patent Application Publication
(10) Pub. No.: US 2024/0270181 A1
(43) Pub. Date: Aug. 15, 2024

(54) TRIM PANEL FOR A MOTOR VEHICLE COMPRISING A LIGHT TRANSMISSION ZONE AND A MASKING ZONE

(71) Applicant: COMPAGNIE PLASTIC OMNIUM SE, LYON (FR)

(72) Inventor: Gilles MOULIN, Sainte-Julie (FR)

(73) Assignee: COMPAGNIE PLASTIC OMNIUM SE, LYON (FR)

(21) Appl. No.: 18/437,893

(22) Filed: Feb. 9, 2024

(30) Foreign Application Priority Data
Feb. 10, 2023 (FR) 2301250

(51) Int. Cl. B60R 13/04

(52) U.S. Cl. CPC B60R 13/04

(57) ABSTRACT

The trim panel for a motor vehicle includes at least one light transmission zone, made of a first plastic material suitable for light transmission, at least one masking zone adjacent to the transmission zone and made at least in part of a second plastic material more flexible than the first material.

### TECHNICAL FIELD

The present disclosure concerns a trim panel for a motor vehicle, as well as a trim module, a motor vehicle front end or a motor vehicle comprising such a trim panel.

### BACKGROUND ART

It is already known in the prior art, a motor vehicle including a front face including in particular a trim module that can integrate technical features, such as sensors or signaling members, and aesthetic features, such as members for diffusing light patterns. Such a trim module has a high added value and is expensive to manufacture and fragile. The arrangement of the trim module in the front face leads to significant exposure of said module to risks of damage, for example during the front impact of the vehicle. More precisely, the trim module includes a trim panel forming an external surface visible from the outside when the trim module is mounted on the vehicle, this trim panel, which is expensive and complex to produce, is thus particularly exposed to impacts.

The trim panel typically includes at least one light transmission zone, made of a first material capable of transmitting light, and at least one masking zone adjacent to the light transmission zone, the masking zone being generally opaque to visible light or semi-transparent. The light transmission zone allows light to pass from the inside of the trim module to the outside, for example, to transmit a light signal, illuminate the road, or display decorative elements. The masking zone can be used to conceal technical elements such as sensors, fastening interfaces or sealing elements, in order to improve the aesthetic appearance of the vehicle. Traditionally, the trim panel is formed by at least one part made of a transparent material, for example polycarbonate transparent to visible light, and at least one other part, made of the same material but opaque, for example opaque polycarbonate, overmolded onto the first part in the area of at least one zone of the trim panel that is to be made opaque.

Thus, at a masking zone, the trim panel includes two layers of material, for example a layer of transparent polycarbonate and a layer of opaque polycarbonate, and is therefore more rigid than at the light transmission zone, which comprises only one layer of material, for example a layer of transparent polycarbonate. This increase in rigidity at the masking zone modifies the behavior of the trim panel during an impact, making it more rigid and therefore more fragile and susceptible to damage, for example by being plastically deformed during an impact.

During a low-speed impact or a small impact, such as impacts called “insurance” impacts, “parking” impacts, “repairability” impacts, the main objective is to reduce the repair costs and/or to protect the element or elements directly or indirectly undergoing the impact. A low-speed impact or a small impact are low-kinetic energy shocks, less than 1000 J. Typically, an “insurance” impact corresponds to an impact at about 15 km/h against a fixed wall, such as that known under the name Danner or AZT, or at about 8 km/h against a wall angle or against a post. A “parking” impact is an impact occurring at less than 8 km/h.

In this way, it is particularly desirable to prevent or limit damage to the trim panel, especially in the event of a low-speed or small impact, so that the trim panel or trim module does not have to be replaced.

### SUMMARY

One of the aims of the present disclosure is to improve the mechanical impact resistance of a trim panel, in particular to reduce or prevent damage to the trim panel in the event of a low-speed or small impact.

To this end, the present disclosure relates to a trim panel for a motor vehicle including
at least one light transmission zone, made of a first plastic material suitable for light transmission, and
at least one masking zone adjacent to the light transmission zone and made at least in part of a second plastic material more flexible than the first plastic material.

The fact that the second plastic material is more flexible than the first plastic material reduces the rigidity of the trim panel compared with a prior art trim panel. The use of this second material thus makes it possible to reduce the rigidity of the trim panel in the masking zone, so that if an impact occurs in the masking zone, the trim panel is sufficiently flexible in this masking zone to be moved a certain distance without undergoing plastic deformation. The use of this second material also makes the entire trim panel more flexible. In particular, in the event of an impact, the relative flexibility of the masking zone allows elastic deformation of the latter, enabling the transmission zone to move, which is not possible with a prior art trim panel, which is particularly rigid in its masking zone. This reduces the risk of damage to the trim panel in the event of an impact, particularly in the event of a low-speed or small impact.

The light transmission zone allows at least some of the light passing through it to be transmitted. In some embodiments, it may be transparent or translucent. An element is considered transparent when it allows light to pass through it in the visible range. A transparent element allows objects to be clearly distinguished through its thickness. An element is considered transparent when its transmittance is greater than or equal to 85%. An element is considered translucent when it allows light to pass through it in the visible range, but without allowing objects to be clearly distinguished. A translucent element is one through which vision is blurred. An element with a transmittance greater than or equal to around 50% and less than 85% is considered translucent. The transmittance or light transmission of a material is the fraction of luminous flux passing through it. Transmittance represents the ratio of light intensity transmitted by the material to the incident light intensity.

The masking zone can be used to conceal, from the outside, technical elements such as sensors, fastening interfaces or sealing elements, in order to improve the aesthetic appearance of the vehicle. In some embodiments, the masking zone can be opaque, semi-transparent or translucent. An element is opaque when it does not let visible light through. An element is semi-transparent when it allows the transmission of light emitted by a light source with possible partial light absorption, but prevents the transmission of natural light. In this way, a semi-transparent masking zone enables elements arranged behind it to be concealed from the outside, while at the same time allowing part of the light emitted by a light source concealed behind the masking zone to be transmitted to the outside. In embodiments where the masking zone is translucent, the transmittance of the masking zone remains lower than the transmittance of the light transmission zone.

The respective flexibilities of the first and second plastic materials can be easily determined by the person skilled in the art using standard measurement methods for determining, for example, the Young's modulus and/or hardness of the first and second plastic materials. For example, a tensile test can be carried out to measure Young's modulus, or hardness can be measured according to one of the Shore hardness scales (defined, for example, by ISO 48-4:2018, ASTM D 2240 and DIN 53505). Other methods well known to the person skilled in the art can of course be used to determine the relative flexibility of the first and second plastic materials.

In some embodiments, the trim panel may include multiple light transmission zones and/or multiple masking zones.

The disclosed embodiments may comprise one or more of the following optional features, taken alone or in combination:

The second plastic material is opaque to visible light.

The second plastic material is semi-transparent.

The second plastic material is translucent, the light transmittance of the second plastic material being lower than the light transmittance of the first plastic material.

The masking zone is more flexible than the light transmission zone.

The masking zone is made entirely from the second plastic material.

The masking zone includes at least two layers of materials:
a first layer made from the first plastic material and located on at least one outer face of the trim panel, and
a second layer made from the second material and located on at least one inner face of the trim panel.

The first layer is integral with the first plastic material forming the light transmission zone.

The first layer includes at least one recess which locally reduces the thickness of the first layer, and at least part of the second layer is arranged in this recess.

The masking zone extends all the way around the light transmission zone.

The trim panel forms a housing, with at least part of the masking zone forming at least one of the side walls of the housing, and the light transmission zone forming at least part of a bottom of the housing.

At least part of the masking zone separates two light transmission zones.

The first plastic material is 5 to 15 times more flexible than the second plastic material.

The present disclosure also relates to a trim module including a trim panel as described above.

The present disclosure also relates to a motor vehicle front end including a trim panel as described above.

Furthermore, the trim panel according to the present disclosure can be included in a motor vehicle tailgate.

Finally, the present disclosure relates to a motor vehicle including a trim panel as previously described.

### BRIEF DESCRIPTION OF THE DRAWINGS

The present disclosure will be better understood upon reading the following description, which is provided merely as a non-limiting example and with reference to the appended drawings, wherein:

FIG. 1 is a schematic perspective representation of a front part of a motor vehicle including a trim module including a trim panel according to a first embodiment;

FIG. 2 is a schematic perspective representation similar to FIG. 1 of a motor vehicle including a trim module including a trim panel according to a second embodiment;

FIG. 3 is a schematic perspective representation of the trim panel shown in FIG. 1;

FIG. 4 is an enlarged schematic perspective representation of the circle C1 shown in FIG. 3;

FIG. 5 is a schematic cross-sectional representation of multiple variants of the trim panel of the first embodiment along the sectional plane YY;

FIG. 6 is a schematic perspective representation of a trim panel according to a third embodiment;

FIG. 7 is an enlarged schematic perspective representation of the circle C2 shown in FIG. 6; and

FIG. 8 is a schematic cross-sectional representation of a plurality of variants of the trim panel of the third embodiment along the sectional plane ZZ.

### DETAILED DESCRIPTION

In the detailed description, the longitudinal direction (or X-axis), the transverse direction (or Y-axis) and the vertical direction (or Z-axis) refer to the directions of a motor vehicle and are shown the figures.

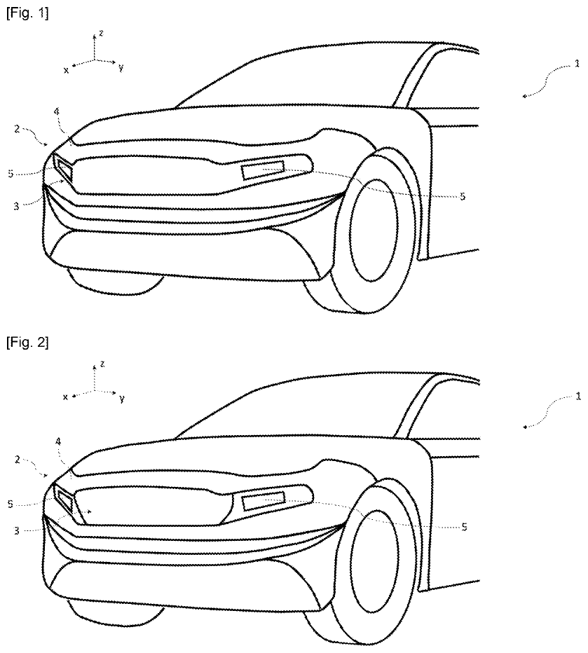

FIG. 1 shows the front part of a motor vehicle 1 that includes a front face 2 including a trim module 3. According to the present disclosure, “front face” is understood to mean the part or parts of the motor vehicle 1 delimiting an external surface visible from outside in front of the motor vehicle 1.

The front panel 2 includes at least one main panel 4 made of plastic material. This main panel 4 has a central orifice wherein the trim module 3 and the optical units 5 are mounted (FIG. 1). In the present embodiment, the two optical units 5 are integrated into the trim module 3 and are arranged respectively at two opposite lateral ends of the trim module 3. This integration of the optical units 5 into the trim module 3 facilitates the mounting of the front face 2 on the motor vehicle 1 and improves the aesthetics of the vehicle 1 by making it possible, for example, to obtain a continuity of shape between the trim module 3 and the optical units 5.

The trim module 3 is arranged in such a way that its external surface is flush with the external surface of the main panel 4. The external surface of the trim module 3 and the external surface of the main panel 4 are in continuity of shape in order to create an effect giving the illusion that the front face 2 is a single piece. In general, the trim module 3 is preferably arranged so that its outer surface is flush with any bodywork elements located in the immediate vicinity of the trim module 3.

According to a second embodiment represented in FIG. 2, the front face 2 differs in that the optical units 5 are not integrated into the trim module 3. The optical units 5 retain the same position on the vehicle 1 as in the first embodiment, so that the trim module 3, arranged between these optical units 5, is shorter than in the first embodiment.

In the first embodiment, the trim module 3 has a general elongated shape extending over more than 50% of the width of the front face 2. More particularly, in the present case, the trim module 3 extends over about 90% of the width—that is, the dimension along the transverse axis Y—of the front face 2. Of course, according to alternative embodiments, the trim module can extend across less than 50% or more than 90% of the front face 2. The trim module 3 may be attached to a support structure of the motor vehicle 1, for example on the body of the motor vehicle 1 or on a front technical face of the vehicle 1.

The trim module 3 comprises an electromagnetic wave scattering member. In the present embodiment, this electromagnetic wave scattering member is able to emit electromagnetic waves in the visible spectrum, commonly called visible light hereinafter. This diffusion member includes for example a light guide coupled to a light emitter (not shown). According to other embodiments, the electromagnetic wave scattering member is able to emit other types of electromagnetic waves, for example infrared waves or radio waves. Provision may be made for the trim module 3 to include multiple electromagnetic wave diffusion members, each member being able to diffuse one or more types of electromagnetic waves.

The trim module 3 further includes a trim panel 6 forming the outer surface of the trim module 3 visible from the outside. Together with a main body (not shown) of the trim module 3, the trim panel 6 forms a housing including the various technical components of the trim module 3, such as an electromagnetic wave scattering member, a light guide or a sensor.

The trim panel 6 includes at least one light transmission zone 7, made of a first plastic material suitable for light transmission. Such a material is, for example, transparent or translucent. In particular, this first material can be polycarbonate (PC) transparent to visible light. Other materials that are transparent or translucent to visible light and known to the person skilled in the art can be used in other embodiments. These materials are selected from transparent or translucent plastics such as, but not limited to, polypropylene, polyethylene terephthalate (PET), polymethyl methacrylate (PMMA), acrylonitrile butadiene styrene (ABS), a mixture of polycarbonate and acrylonitrile butadiene styrene (PC/ABS), polyurethane (PU), a cyclic olefin copolymer (COC), or a cyclic olefin polymer (COP).

In this first embodiment, the trim panel 6 includes a single light transmission zone 7. In other embodiments, the trim panel 6 may include a greater number of light transmission zones 7, for example between two and twenty, preferably between two and ten. In this case, the light transmission zone 7 occupies a larger part of the outer surface of the trim panel 6 and therefore of the trim module 3. The light transmission zone 7 allows in particular visible light to pass from the inside of the trim module 3 to the outside, for example, to transmit a light signal, illuminate the road, or display decorative elements. In particular, in the embodiments where the trim module 3 includes optical units 5, the light transmission zone 7 allows visible light emitted by these optical units 5 to pass through.

The trim panel 6 also includes a masking zone 8 adjacent to the light transmission zone 7 and made of a second plastic material that is more flexible than the first plastic material. In this embodiment, the masking zone 8 is opaque to visible light. According to one embodiment, the masking zone can be semi-transparent or translucent.

The second material is for example chosen from, but not limited to, opaque, semi-transparent or translucent thermoplastic elastomers (TPEs), such as TPEs based on styrenic block copolymers (SBCs), e.g. SBCs in saturated form, typically polystyrene-block-polyethylene-butylene-block-polystyrene (SEBS), or opaque, semi-transparent or translucent thermoplastic polyurethanes. Transparent polycarbonate has a high Young's modulus of between 2,100 and 2,500 MPa, well above the Young's modulus of an opaque, semi-transparent or translucent thermoplastic elastomer or an opaque, semi-transparent or translucent thermoplastic polyurethane. In particular, the masking zone 8 can be used to conceal technical elements, such as fastening interfaces, technical walls, sensors or sealing elements, in order to improve the aesthetic appearance of the vehicle. Conventionally, the material used in the prior art to impart visible light opacity to the masking zone 8 was a material identical to that used to produce the light transmission zone, in particular to facilitate the molding manufacturing process. For example, opaque polycarbonate was overmolded onto transparent polycarbonate to form the masking zone 8. As a result, the masking zone included a greater thickness of polycarbonate, stiffening this masking zone 8 as well as the trim panel 6 as a whole. This stiffening resulted in poorer mechanical resistance to impact. The use of a second, more flexible plastic material than the first reduces the rigidity not only of the masking zone 8, but also of the trim panel 6 as a whole, and thus improves the mechanical impact resistance of the trim panel 6—and therefore of the trim module 3. In particular, in the event of an impact on the light transmission zone 7, the masking zone 8 adjacent to this transmission zone, due to its greater flexibility, deforms more easily and allows the light transmission zone 7 to be displaced, thereby reducing the impact on this zone of the trim panel 6. FIGS. 1 and 2 show the trim module 3 schematically. Note in particular that the masking zone 8 is not shown.

In other embodiments, the trim panel 6 may include a greater number of masking zones 8, for example between two and twenty, preferably between two and ten.

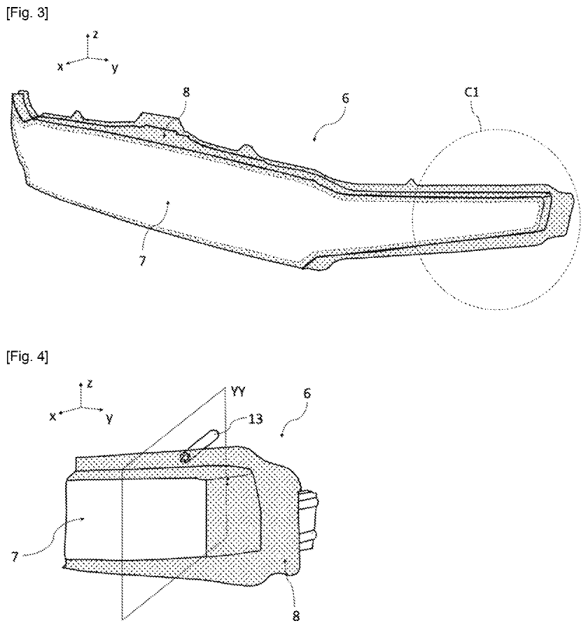

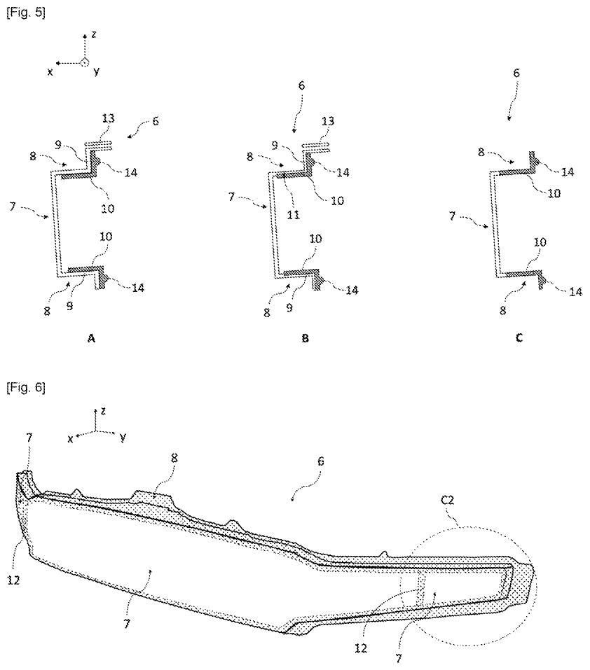

As shown in FIG. 3, the masking zone 8 extends all the way around the light transmission zone 7. This further increases the flexibility of the masking zone 8 and therefore the flexibility of the trim panel 6, whatever the impact zone in the event of an impact. If the trim panel 6 includes multiple light transmission zones 7, a masking zone 8 may extend around the perimeter of each light transmission zone 7.

In the first embodiment, the trim panel 6 has the general shape of a housing (FIGS. 3 and 4), with the masking zone 8 forming the four side walls of the housing, and the light transmission zone 7 forming the bottom of the housing with part of the masking zone 8. In this configuration, the bottom of the housing, which forms the visible outer surface of the trim module 3, is particularly vulnerable to impact. In particular, in this configuration, the side walls of the housing, by virtue of their positions, increase the rigidity of the bottom of the wall (sometimes referred to as the “box effect”). The use of a second, more flexible plastic material to create the masking zones 8, and therefore the side walls of the housing, mitigates this increase in the rigidity of the case base obtained by the box effect, and therefore improves the mechanical impact resistance of the trim panel 6.

In FIGS. 3, 4, 6 and 7, the masking zone(s) 8 are shown dotted to represent their opacity.

FIG. 5 shows multiple alternative versions of a vertical cross-section along the YY sectional plane shown in FIG. 4. The difference between these different versions concerns the elements forming the masking zone 8.

As can be seen in FIGS. 4 and 5, the trim panel 6 includes at least one screw shaft 13 by means of which the trim panel 6 can, for example, be screw-fastened to the main body of the trim module 3. Preferably, this screw shaft 3 is in the form of a hollow protrusion extending behind the outer layer 9 of the masking zone 8 and is preferably formed during molding from the first transparent or translucent material. The trim panel 6 can be attached to the main body of the trim module 3 in different ways, for example by, but not limited to, clipping or gluing.

According to a first embodiment shown in FIG. 5A, the masking zone 8 is formed by two layers of material of substantially equivalent thickness:
a first layer 9 made from the first plastic material on the outside of the panel, and
a second layer 10 made from the second plastic material and located on the inside of the panel.

As previously explained, this variant is advantageous in that the second layer is more flexible than the first layer. Thus, compared with a prior art trim panel in which this part is made using materials with a high degree of hardness for both layers (e.g. two layers of polycarbonate, transparent and opaque), the masking zone 8 is more flexible, which improves the mechanical impact resistance of the trim panel 6. This variant is also particularly easy to implement.

As can be seen in FIG. 5A, the first layer 9 of the masking zone 8 formed from the same piece forming the light transmission zone 7. In particular, the first layer 9 of the masking zone 8 is made from the same first material as that used to create the light transmission zone 7. This facilitates the method for manufacturing the trim panel 6. For example, a thermoplastic material such as, but not limited to, polycarbonate, transparent to visible light, can be molded to form a piece beforehand, one part of which forms the light transmission zone 7 and one part of which forms the masking zone 8. To produce the masking zone 8, the part forming the masking zone 8 is overmolded with the second material, for example an opaque, semi-transparent or translucent thermoplastic elastomer, to produce the second layer 10 of the masking zone 8 of the trim panel 6. It is the opaque, semi-transparent or translucent second layer 10 that delimits the light transmission zone 7 from the masking zone 8. In addition, in the case of such a molding manufacturing process by molding a thermoplastic material, the use of a second material that is more flexible than the first material reduces the two-layer thermal effect during molding, thus improving the precision and reproducibility of the part geometry. The second flexible material exerts less force when it shrinks as it cools during the molding process, thus preventing or reducing the deformation of the first, already-molded material to which it adheres. This reduction in the two-layer effect is all the more advantageous as this effect is greater on large pieces, particularly on large elongated pieces, as is the case for the trim panel 6 according to the disclosed embodiments.

The second layer 10 includes a bead 14 that may be compressed with a partial crush or may be inserted into a groove of another element of the trim module 3 3. This makes it easy to seal the inside of the trim module without having to add a gasket or resort to bonding to achieve both fastening and sealing. In some embodiments, however, a bead of adhesive may be applied to seal and hold the trim panel 6 to the main body of the trim module 3.

The second variant shown in FIG. 5B differs from the first variant only in that the first layer 9 has at least one recess 11 locally reducing the thickness of the outer layer 9, at least part of the second layer 10 being arranged in this recess 11. In the present embodiment, this recess 11 is located in the sectional plane YY. This recess 11 makes it possible to locally reduce the rigidity of the masking zone 8.

The third variant shown in FIG. 5C differs from the first variant in that the masking zone is made entirely from the second material. In other words, compared with the first variant, the masking zone 8 does not include the first layer 9 but only the second layer 10. This configuration significantly increases the flexibility of the masking zone 8, so that the masking zone 8 is more flexible than the light transmission zone 7. This flexibility of the masking zone 8 makes it possible to reduce the overall rigidity of the trim panel 6, so that the mechanical impact resistance of the trim panel 6, and therefore of the trim module 3, is improved. In this variant, the screw shaft 13 is not present in the cross-section. This is because it is preferable for the screw shaft to be made of a more rigid material than the second material used to make the second layer 10. In this way, the trim panel 6 may include screw shafts 13 arranged elsewhere on the trim panel 6. Alternatively, the trim panel 6 can be attached to the main body of the trim module 3 without using a screw shaft 13.

In yet another variant, the masking zone 8 can be made more flexible than the transmission zone, without the masking zone 8 having to be made entirely from the second material.

It is understood that the same trim panel 6 can implement multiple variants described below, depending on the section considered.

FIG. 6 schematically shows a third embodiment of a trim panel 6 according to the disclosed embodiments. The third embodiment differs from the first embodiment mainly in that it includes multiple light transmission zones 7 separated from each other by the masking zone 8. More particularly, according to this embodiment, the trim panel 6 includes three light transmission zones 7, the masking zone 8 extending mainly around the entire perimeter of each light transmission zone 7 and the masking zone 8 also having two masking straps 12 each extending substantially vertically from an upper end of the light transmission zone 7 to a lower end of the light transmission zone 7 in order to separate it into three light transmission zones 7.

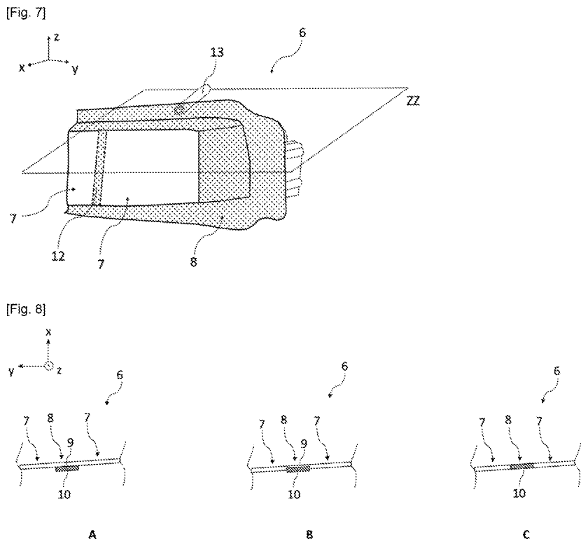

FIG. 7 is a similar view to FIG. 4, but this time applied to the third embodiment and showing the enlarged circle C2 of FIG. 6. FIG. 8 shows three alternative versions of the third embodiment, seen in cross-section along the sectional plane ZZ shown in FIG. 7. FIG. 8 shows a cross-section of the trim panel 6 at one of its two masking straps 12.

FIG. 8A shows the first variant of the third embodiment. In a similar way to the first variant of the first embodiment, the masking zone 8 at the masking strap 12 of this first variant includes a first layer 9 made from the first plastic material and located on an outer face of the trim panel 6 and a second layer 10 made from the second plastic material and located on an inner face of the trim panel 6. Thanks to this configuration, the overall rigidity of the trim panel 6 is reduced, particularly compared with the prior art, which includes a double layer of rigid materials in the masking zones 8. The masking strap 12 according to this first variant forms a connecting zone between two light transmission zones 7, giving them greater freedom of movement relative to each other, which improves the mechanical impact resistance of the trim panel 6.

FIG. 8B shows a second variant of the third embodiment. In a similar way to the second variant of the first embodiment, the second variant differs from the first variant of the third embodiment in that the first layer 9 has at least one recess 11 locally reducing the thickness of the first layer 9, at least part of the second layer 10 being arranged in this recess 11. In the present case, this recess 11 is located in the sectional plane ZZ. This recess 11 makes it possible to locally reduce the rigidity of the masking ring 12.

FIG. 8C shows a third variant of the third embodiment. Similar to the third variant of the first embodiment, the third variant differs from the first variant of the third embodiment in that the masking zone 8 formed by the masking strap 12 is made entirely from the second plastic material. In other words, compared with the first variant of the third embodiment, the masking zone 8 formed by the masking strap 12 does not include the first layer 9, but only the second layer 10. This configuration significantly increases the flexibility of the masking zone 8 formed by the masking strap 12, so that this zone is more flexible than the light transmission zone 7. This flexibility makes it possible to reduce the overall rigidity of the trim panel 6, so that the mechanical impact resistance of the trim panel 6 is improved. The flexibility of the masking strap 12, which separates two light transmission zones 7, enables it to perform a function similar to that of a hinge between these two light transmission zones 7, allowing them to move more freely relative to each other, thereby reducing the overall rigidity of the trim panel 6 and thus improving the mechanical impact resistance of the trim panel 6.

Advantageously, the masking straps 12 can be designed to protrude from an inner face of the trim panel 6 to act as a mask to limit potential light leakage, for example from the optical units 5.

The present disclosure is not limited to the embodiments presented, and other embodiments will become clearly apparent to the person skilled in the art. In particular, it is possible to combine the different variants within a single embodiment with one another, or to combine the different variants of different embodiments with one another.

The trim panel 6 according to the present disclosure is shown above in the context of its integration into a front panel 2 of a motor vehicle 1. A trim panel 6 according to the disclosure can be integrated at the rear of the vehicle, for example on a tailgate of the motor vehicle.

What is claimed is:

1. A trim panel for a motor vehicle characterized in that it comprises:
at least one light transmission zone, made of a first plastic material suitable for a light transmission, and
at least one masking zone adjacent to the at least one light transmission zone and made at least in part of a second plastic material more flexible than the first plastic material.

2. The trim panel according to claim 1, wherein the second plastic material is opaque to a visible light.

3. The trim panel according to claim 1, wherein the second plastic material is semi-transparent.

4. The trim panel according to claim 1, wherein the second plastic material is translucent, wherein a light transmittance of the second plastic material is lower than the light transmittance of the first plastic material.

5. The trim panel according to claim 1, wherein the at least one masking zone is more flexible than the at least one light transmission zone.

6. The trim panel according to claim 1, wherein the at least one masking zone is made entirely from the second plastic material.

7. The trim panel according to claim 1, wherein the at least one masking zone is formed of at least two layers of materials:
a first layer made from the first plastic material and located on an at least one outer face of the trim panel, and
a second layer made from the second material and located on an at least one inner face of the trim panel.

8. The trim panel according to claim 7, wherein the first layer is integral with the first plastic material forming the at least one light transmission zone.

9. The trim panel according to claim 7, wherein the first layer has at least one recess locally reducing the thickness of the first layer, and wherein at least part of the second layer is arranged in the at least one recess.

10. The trim panel according to claim 1, wherein the at least one masking zone extends around an entire circumference of the at least one light transmission zone.

11. The trim panel according to claim 1, wherein the trim panel forms a housing, at least part of the at least one masking zone forms at least one wall of side walls of the housing, and the at least one light transmission zone forms at least part of a bottom of the housing.

12. The trim panel according to claim 1, wherein at least part of the at least one masking zone separates two light transmission zones.

13. The trim panel according to claim 1, wherein the first plastic material is 5 to 15 times more flexible than the second plastic material.

14. A trim module for a motor vehicle characterized in that it comprises a trim panel, wherein the trim panel further comprises:
at least one light transmission zone, made of a first plastic material suitable for a light transmission,
at least one masking zone adjacent to the at least one light transmission zone and made at least in part of a second plastic material more flexible than the first plastic material.

15. A front face of a motor vehicle comprising a trim panel, wherein the trim panel further comprises:
at least one light transmission zone, made of a first plastic material suitable for a light transmission,
at least one masking zone adjacent to the at least one light transmission zone and made at least in part of a second plastic material more flexible than the first plastic material.

16. A motor vehicle comprising a trim panel according to claim 1.
